(19) United States
(12) Patent Application Publication
(10) Pub. No.: US 2017/0011322 A1
(43) Pub. Date: Jan. 12, 2017

(54) BUSINESS PROCESS MANAGMENT

(71) Applicant: HEWLETT PACKARD ENTERPRISE DEVELOPMENT LP, Houston, TX (US)

(72) Inventor: Jeffery D. Thomas, Plano, TX (US)

(21) Appl. No.: 15/113,257

(22) PCT Filed: Jan. 31, 2014
(86) PCT No.: PCT/US2014/014237

§ 371 Date: Jul. 21, 2016

(51) Int. Cl. G06Q 10/06

(52) U.S. Cl. CPC G06Q 10/06316; G06Q 10/067

(57) ABSTRACT

Business process management can include instantiating a composite instance of a business process using a business model and delegating management operations to a running domain to manage the business process.

### BACKGROUND

A cloud service generally refers to a service or service hosting construct that allows end recipient computer systems, e.g., thin clients, portable computers, smart phones, desktop computers, other applications, services or systems, to access a pool of hosted computing, networking and network resources, storage, and/or storage resources, e.g., the cloud resources exposed over a network such as the Internet, for example. In this manner, the hosting company, such as a cloud service provider, may, for example, provide software as a service (SaaS) by hosting applications, infrastructure as service (IaaS) by hosting equipment (servers, storage components, network components, etc.), or a platform as a service (PaaS) by hosting a comprehensive computing platform (operating system, middleware, data bases, associated lifecycle management functions such as auto-scaling infrastructure, eta).

### BRIEF DESCRIPTION OF THE DRAWINGS

FIG. 1 illustrates an example of an environment in which various example processes can be implemented for business process management according to the present disclosure.

FIG. 2 is a block diagram of an example lifecycle associated with a business process in accordance with the present disclosure.

FIG. 3 illustrates a diagram of an example of a system for business process management according to the present disclosure.

FIG. 4 illustrates a diagram of an example of a computing device for business process management according to the present disclosure.

FIG. 5 illustrates a flow diagram of an example of a method for business process management according to the present disclosure.

### DETAILED DESCRIPTION

With increasing pressure on organizations to improve their performance, the organizations may seek to increase efficiencies related to their business processes, for instance, by pursuing efficiencies related to the business processes over a lifecycle of the business process. A business process refers to a collection of related structured activities or tasks that produce a specific service or product (serve a particular goal) for a particular customer or customers. A lifecycle of a business process includes development of the business process (e.g., a development phase), deployment of the business process (e.g., a deployment phase), and/or management of the business process (e.g., a management phase).

Development of the business process refers to development of industry or business specific business processes, among other types of business process. A business process can be developed by a business (e.g., for individual or enterprise use within their own business) and/or developed by a business on behalf to another business (e.g., a business to ultimately utilize the business process). Developing can include development of new (not previously existing) and/or modification of some/all of an existing business process. Development can include developing a service specification, such as those described herein, that can be included in a specification representative of the business process.

Following development, a business process, such as composite instance of a business process, can be deployed. A composite instance of a business process refers to a collection of information, representative of each component of a business process (e.g., representative of vertical and horizontal business process levels of a business process), assembled during development of a business process and subsequently passed to deployment and management phases of the business process for utilization in the deployment and/or management phases. For example, the composite instance can include information (e.g., a representative of all facets of the business process), that can be utilized during development, deployment, and management of business process, respectively.

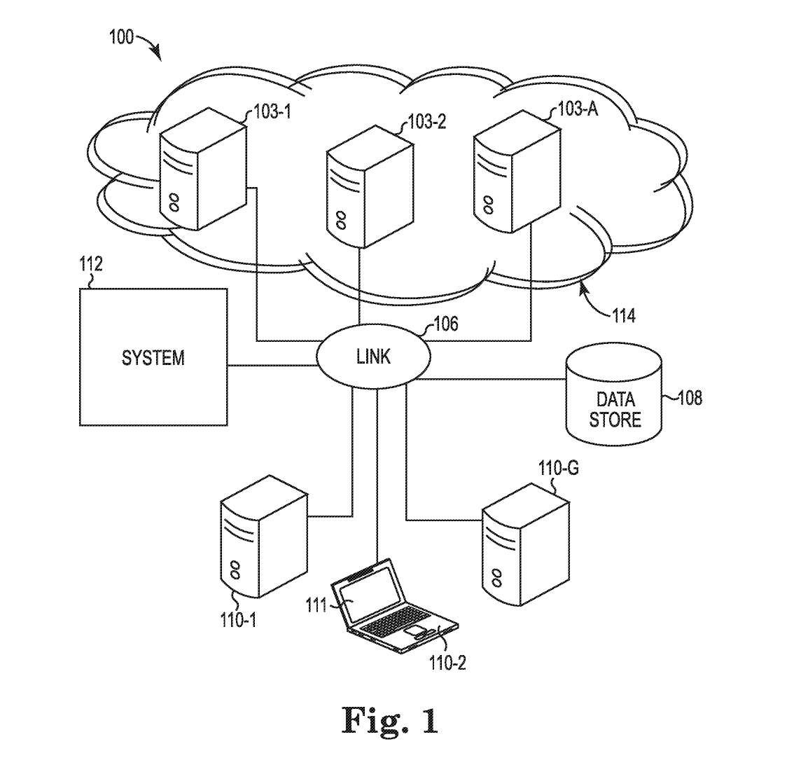

A business process can be deployed (e.g., automatically deployed in response to development of the composite instance) on software and/or hardware resources included in an environment, such as environment 100 as described herein with respect to FIG. 1. Deployment can include creation of an application and/or service based upon reusable application framework and/or a reusable service frameworks (such as those stored in a data store) and compiling a specification representative of the business process, as described herein. An application refers to a collection of computer software (e.g., machine readable instructions) that causes a computer to perform useful tasks beyond the running of the computer itself. Examples of applications include a software application, application program, custom industry-specific application, among others. A service refers to a coherent, ready-to-use deliverable that is of value to the customer. For example, a service can allow a customer to do business without worrying about underlying technology and/or IT infrastructure.

A created application and/or service can have a service deployment definition and/or a service specification associated therewith. The service deployment definition can include, for example, a customer-defined service level agreement (SLA), a security policy, an event management policy, and/or a capacity management policy, among other information or policies, associated with the created application and/or service. The service deployment definition, a service specification (e.g., a web-service specification, etc.), and/or actual runtime data associated with the created application and/or service, among other information (e. client specified information) can be compiled into (e.g., included in) a specification representative of the business process.

The specification representative of the business process can be used to create a runbook corresponding to a particular business process (e.g., a created application and/or service for a particular business process). A runbook refers a compilation of management operations (e.g., procedures and/or operations) corresponding to a particular business process. The management operations can include predefined workflows, such as those, commonly used to manage other business process (e.g., running applications and/or services in a managed environment). For example, the management operations can include initiating changes (e.g., to a business process and/or a cloud-based computing system, etc.) and/or various other management operations including application versioning. Application versioning refers to assignment and/or modification of version information associated with a particular business process, application, and/or service, such as those described herein.

Following deployment, a business process can be managed, for instance, based on a runbook. For instance, business process management can include automatically initiating management operation included in a runbook. Management operations that can be related to configuration management, upgrades, and process automation, among other management functions, typically initiated manually/using centralized point of control associated with business process management, an application, and/or a service.

Integrating the development phase, the deployment phase, and the management phase of the lifecycle of the business process, such as transferring data related to one phase of the lifecycle (e.g., development) to another phase of the lifecycle (e.g., deployment) can be difficult, costly (e.g., time-consuming), and/or ineffective, among other difficulties. Moreover, approaches attempting to integrate phases of the lifecycle may not be able to fully perform various functions associated with a particular phase of the lifecycle. In particular, difficulties with business process management, for instance, using a centralized point of control can include an inability to delegate control to other entities (e.g., an infrastructure as service (laaS) runtime service).

Such difficulties can be compounded by changes to the business process that occur after completion of an original development phase (e.g., after a business process is ready to be deployed). For instance, such approaches may not account for “front-end” changes to the business process requested after deployment of a business process, among other difficulties. A “front-end” change may impact phase(s) of the lifecycle of the business process, such as development and/or management. An inability and/or difficulty associated with transfer of information between phases of the lifecycle, centralized control without an ability to delegate control, and/or a lack of accounting for ‘front-end’ changes may undesirably impact development, deployment, and/or management of a business process.

In contrast, examples of the present disclosure include methods, systems, and computer-readable and executable instructions for business process management. Business process management can, for example, include instantiating a composite instance of a business process using a business model and delegating management operations to a running domain to manage the business process. Such business process management can promote automated management operations, for instance, management operations automatically initiated by a running domain, among other advantages.

FIG. 1 illustrates an example of an environment 100 in which various example processes can be implemented for business process management according to the present disclosure. The environment 100 is shown to include a system 112 for business process management, computing devices 103-1, 103-2, . . . , 103-A, workstations 110-1, 110-2, . . . , 110-G, a data store 108, a link 106, and a cloud-based computing system 114. The data store 108 can be analogous to the data store discussed with respect to FIG. 3.

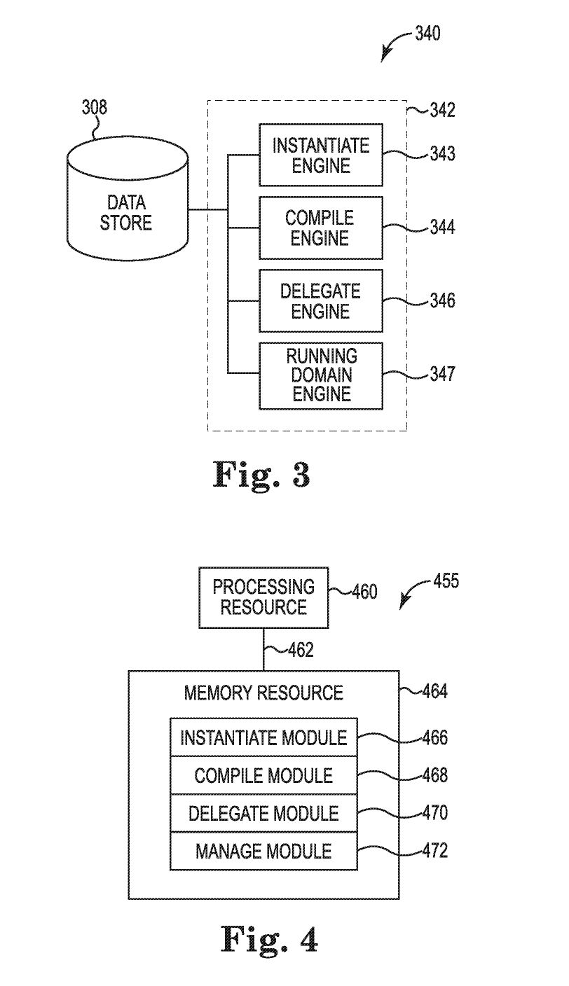

The system 112 for business process management can represent different combinations of hardware or hardware and instructions to manage business processes. The system 112 for business process management can include a computing device (not shown), for instance, computing device 455 as discussed with respect to FIG. 4. The system 112 can include engines analogous to engines described herein with respect to FIG. 3. For example, the system 112 can include an instantiate engine, a compile engine, a delegate engine, and running domain engine, as described herein with respect to FIG. 3.

Business processes and/or applications or services created for a particular business process can be viewed using a workstation, such as workstations 110-1, . . . , 110-G, link 106, data store 108, and/or servers, such as those described herein. Workstations 110-1, . . . , 110-G represent devices that can generate/receive electronic data having browsers and/or other applications to communicate such data and/or facilitate viewing of business process management, among other abilities. Examples of workstations 110-110-G include desktop/laptop computers, mobile phones, and/or servers, among other devices suitable for managing business process. Each cloud-based computing system 114 can have a respective workstation(s) corresponding thereto.

In various examples, the workstations 110-1, . . . , 110-G and/or data store(s) 108 can be separate and distinct from the cloud-based computing system 114. As described herein, being separate and distinct refers to an environment being physically separate and/or having separate network resources (e.g., network resources to monitor traffic) with respect to each other. In this manner, a workstation can monitor (e.g., remotely monitor) traffic from and/or usage associated with the cloud-based computing system 114 (e.g., usage of the computing devices 103-1, . . . , 103-A). However, the present disclosure is not so limited. That is, the workstations 110-1, . . . , 110-G and/or data store(s) 108 can, in some examples, be included the cloud-based computing system 114. Regardless, monitoring of the computing devices 103-1, . . . , 103-A can promote business process management (e.g., an application and/or service created for a business process) utilizing the computing devices 103-1, . . . , 103-A, as described herein.

Business process can undergo various changes throughout the course of their lifecycle. Examples of changes to a business process can include “front-end” change (e.g., changes to client specified information) occurring following deployment of an application and/or service for a particular business process and/or indirect changes, such as changes to a cloud-based computing system 114 on which some/all of a business process is implemented, among other types of changes the business process. Examples of changes to the cloud-based computing system 114 can include changes to a system registry; folders, directories, or files that need to be created; other setting or configuration parameters of a computing device that need to be set to particular values; and so forth, as well as what files (e.g., program and/or data files) that need to be copied to the computing device(s) in the environment 100 and any operations that need to be performed on those files (e.g., some files may need to be decompressed and/or decrypted), among other changes to the cloud-based computing system 114.

In some examples, data store 108 and the computing devices 103-1, . . . , 103-A (e.g., a database) can maintain a record of the changes to a business process and/or changes to cloud-based computing system. Storing changes, can in some examples, enable changes to a business process and/or changes to cloud-based computing system to be automatically reversed, for instance, by reverting to a pre-change state without administrator intervention to bring a business process and/or the environment back into line with the desired state, such as a state (e.g., an SLA and/or performance baseline) stored in the data store 108.

Inadvertent changes may be made to the environment 100 that are not initiated through a running domain. For example, a computing device, such as computing device 103-1 may be accidentally turned off or may fail. Such changes can be recorded in the data store 108 and/or other computing devices, for example, computing device 103-2 automatically (e.g., a system may run that attempts to detect device failures and provide such information to the data store 108 and the computing devices 103-1, . . . , 103-A maintaining a record of the changes) or may be reflected in data store 108 and the computing devices 103-1, . . . , 103-A manually (e.g., manually entered by an administrator notified of such changes).

The workstations 110-1, . . . , 110-G can include an electronic display such as a graphical user interface (GUI) 111. A user interface (UI) can include hardware components and/or computer-readable instruction components. For instance, hardware components can include input components (e.g., a mouse, a touch screen, and a keyboard) and/or output components (e.g., a display). An example UI can include a GUI. A GUI can, for example, electronically represent a status (e.g., a current) of a business process, such as “active”, and/or provide an indication (electronic representation) of a business process associated with an event (e.g., a name, type, and/or identifying information of a business process associated with an event), among other electronic representations.

Such an indication can include, for example, an indication of a business process name, a version of firmware associated with a business process (e.g., a version of firmware associated with an application created for a business process), among other information/indications. Statuses can correspond to events, such as those described herein. For example, an event can have a corresponding status associated therewith (e.g., information that identifies a particular status) provided as an indicator, In some examples, an indicator can be displayed by a UI of a workstation. For example, the indicator can be a numeric indicator, a textual indicator, a pop-up window, and/or a particular color (e.g., display of the color green to indicate a particular business process has a “normal”/“ready” status and/or is not indicated as associated with an event), among other possible types of indicators. Conversely, a red color can be displayed to indicate a particular business process has been associated with an event. Such displays can facilitate interactions between a user and a computer (e.g., allows a user to interact with a computer using images and/or text).

Link 106 (e.g., a network) represents a cable, wireless, fiber optic, and/or remote connection via a telecommunication link, an infrared link, a radio frequency link, and/or other connectors or systems that provide electronic communication. That is, the link 106 can, for example, include a link to an intranet, the Internet, or a combination of both, among other communication interfaces. The link 106 can also include intermediate proxies, for example, an intermediate proxy server, routers, switches, load balancers, and the like.

For instance, the link 106 can include an intermediate server such as an asynchronous protocol server, for example, a java-based server such as an extensible messaging and presence protocol (XMPP) server (not shown) a synchronous server, an extensible markup language (XML) server, and/or an application server (not shown). The asynchronous protocol server can communicate by an asynchronous protocol with the application server, and/or a data store (e.g., data store 108) to promote business process management. However, the present disclosure is not so limited. That is, link 106 can represent a physical connection between the computing devices 103-1, . . . , 103-A and the workstations 110-1, . . . , 110-G to communicate instructions between the workstations 110-1, . . . , 110-G, the intermediate server, the application server, the computing devices 103-1, . . . , 103-A, and/or the data store 108.

In some examples, link 106 can represent a common abstraction layer. That is, the computing devices 103-1, 103-2, . . . , 103-A, and/or the workstations 110-1, . . . , 110-G can be included on a common abstraction language. Such commonality can promote business process management, as described herein.

The cloud-based computing system 114 refers to computational resources that can be linked through the use of computer networks. Allocation of the computation resources can be varied to meet changing demands upon the cloud-based computing system 114. The cloud-based computing system 114 can include a public cloud system, a private cloud system, and/or a hybrid cloud system. For example, an environment (e.g., a traditional, non-cloud IT environment) including a public cloud system and a private cloud system can include or constitute a hybrid environment and/or a hybrid cloud/traditional IT system.

A public cloud system can include a service provider that makes resources (e.g., applications and storage), available to the public over the Internet. A public cloud system can be free or offered for a fee, for example.

A private cloud system can include computing environment that provides hosted services to a limited number of people behind a firewall. For example, a private cloud can include an Enterprise Resource Planning (ERP) system (not shown), a number of computing devices (e.g., databases), and virtualization (e.g., virtual machines) (not shown), among others, For instance, a private cloud system can include a computing environment that provides hosted services to a limited number of the plurality of nodes (e.g., computer) behind a firewall. The ERP, for example, can integrate internal and external management information across an entire enterprise and/or organization.

The computing devices can include an event management database, event archive/knowledge included in a database, a configuration management database (CMDB), and/or a performance metric database, for example. In some examples, some or all of a CMDB can be included in a data store, such as data store 108. Notable, the CMDB, as referred to herein, is an active CMDB that actively links a composite instance of a business process (including the business process model on which the composite instance is based) and/or a specification representative of the business process to an operational model. In contrast to a CMDB that is static (e.g., only gathers information once a business process has been deployed into a running domain), an active CMDB is a prescriptive participant in development and/or deployment of a business process (e.g., an ERP), among other advantages.

The computing device can employ virtualization. Virtualization, for example, can include the creation of a number of virtual resources that are allocated from physical resources but not directly limited by the capabilities of particular physical resources. Examples of virtualized resources include hardware platforms, operating systems, storage devices, and/or network resources, among others. For example, a virtual storage device can provide up to a particular capacity of storage that is physically provided by one, less than one, or more than one physical storage device depending on the amount of storage space allocated to the virtual storage device and therefore not directly limited by the capabilities of any particular device(s). The public cloud system and the private cloud system can be bound together, for example, through the application in the public cloud system and the ERP in the private cloud system.

A hybrid traditional/cloud IT environment, for example, can include a mix of traditional server systems, private cloud systems, public cloud systems, and/or dynamic cloud services. For instance, a hybrid cloud/traditional IT environment can involve interdependencies between physically and logically separated services consisting of multiple systems. A hybrid cloud/traditional IT environment, for example, can include a number of clouds (e.g., two or more clouds) that can remain unique entities but can be bound together.

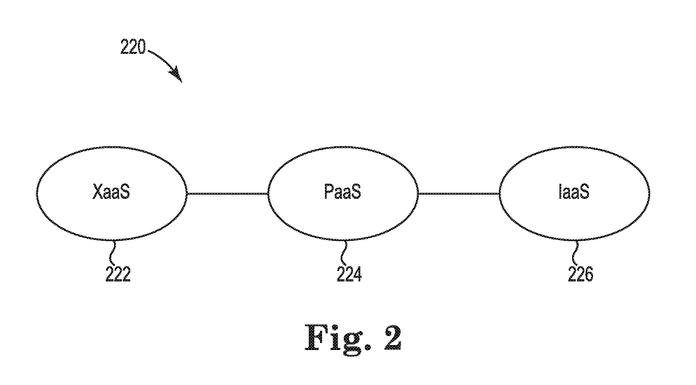

FIG. 2 is a block diagram of an example lifecycle associated with a business process in accordance with the present disclosure. The specification representative of the business process, as described herein, is designed to be used across the entire lifecycle 220 of a business process. The lifecycle 220 of a business process typically includes three phases a development phase (e.g., as illustrated by XaaS 222), followed by a deployment phase (e.g., as illustrated as PaaS 224), followed by a management phase (as illustrated by laaS 226). The phases can be included in a single cloud-based computing system (e.g., cloud-based computing system 114) and/or included in multiple cloud-based computing systems.

While certain aspects are mentioned in regard to a particular phase (e.g., development phase) it is notable that all the phases are interrelated (passing information to and from one to another) and that discussion of a particular element in context of a particular phase should not be deemed to limit the element to the phase. For instance, some/all of a specification representative of the business process can be transferred from one phase to the next in an order suitable to promote business process management as described herein. For instance, as business process management applies to all three phases of the lifecycle 220 of a business process a specification representative of the business process can thus be seen as an integration point for the various phases in the lifecycle 220 of a business process, and facilitates each of these phases.

Additionally, by using the specification representative of the business process, information can be transferred between these phases, such as: information regarding management of the business process (e.g., being fed back to the development phase, allowing the development phase to modify the business process, such as for future versions or to improve the performance of the current version); information of the structure, deployment requirements and operational behavior of the business process; information of the operational environment from the desktop to the data center; information of the service level as observed by the end user; and so forth.

A specification representative of the business process contains all information used to deploy and manage a distributed system, including required resources, configuration, operational features, policies, etc. During the deployment phase 224, the specification representative of the business process is used to automatically deploy the business process and dynamically allocate and configure the software (e.g., machine readable instructions) and hardware (e.g., server, storage and networking) resources used by the business process. The same specification representative of the business process can be used for deployments to different host environments and to different scales. During the management phase 226, information in the specification representative of the business process can relate to an operating system that provides a system-level view for business process management. This enables management tools to drive resource allocation, configuration management, upgrades, and process automation from the perspective of a system (e.g., runtime behavior of the business process occurring in a running domain).

FIG. 3 illustrates a diagram of an example of a system 340 for business process management according to the present disclosure. The system 340 can include a data store 308 (e.g., analogous to data store 108 as referenced in FIG. 1), a business process management system 342, and/or a number of engines. The business process management system 342 can be in communication with the data store 308. The business process management system 342 can include a number of engines (e.g., instantiate engine 343, compile engine 344, delegate engine 346, running domain engine 347, eta). The business process management system 342 can include additional or fewer engines than illustrated to perform the various functions described herein.

The number of engines can include a combination of hardware and programming to perform a number of functions described herein (e.g., a running domain engine initiates management operations, etc.). Each of the engines can include hardware or a combination of hardware and programming designated or designed to execute a module (e.g., a particular module). The programming can include instructions (e.g., software, firmware, etc.) stored in a memory resource (e.g., computer-readable medium) as well as a hard-wired program (e.g., logic).

The instantiate engine 343 can instantiate a composite instance of a business process based on a business process model. Again, the composite instance of a business process refers to a collection of information, representative of each component of a business process, assembled during development of a business process and subsequently passed to deployment and management phases of the business process for utilization in the deployment and/or management phases. In some examples instantiate engine 343 can instantiate new business process and/or instantiate a portion of (e.g,, an modification of an existing portion of the business process) or all of an existing business process.

A business process model refers to a representation (e.g, an electronic and/or visual representation) of some or all of a business process. For example, a business process model can be represented (e.g., visually) by a flowchart including a sequence of activities with interleaving decision points and/or as represented by a process matrix including a sequence of activities with relevance rules based on data in the business process, among other suitable representations to promote business process management. In some examples, a business process model can represent some or all of at least two or more business processes.

The instantiate engine 343 can instantiate a composite instance of the business process based on a business process model (e.g., a reusable business process model). A reusable business process model refers to reusable frameworks (e.g., common to a particular industry) that can enable development of a business process model and can subsequently be reused to develop another similar/identical business process. Reusable models can include code, code libraries, application models based on development patterns, enterprise application patterns, composed patterns, application frameworks, among other reusable components.

A reusable business process model can be used to instantiate a business process. That is, the reusable business process model can be used to instantiate a portion of or all of a business process. For example, a reusable business model can be used to instantiate a portion (e.g., an addition to and/or medication of) an existing business process model and/or instantiate all of a new business process, among other possibilities.

The instantiate engine 343 can instantiate a library. For instance, a library including a plurality of business process models (e.g., a plurality of reusable business process models, such as, industry best practice business process models based on vertical industry and horizontal business process levels, previously developed specifications, such as those described herein, and/or previously developed business process models specific to a requesting client, among other information. The reusable library can be included in an anything as a service layer (XaaS layer) that can, for example, be included in a development phase of a lifecycle of a business process, as described herein. The library can be stored in a data store, such a data store 108, and/or stored in a computing device, such as computing device 103-1.

The instantiate engine 343 can instantiate a composite instance of a business process using a reusable business process model of the plurality of reusable business process models. A composite instance refers to business process model based on vertical business process levels (e.g., within a particular aspect of a business process) and horizontal business process levels (e.g., across various aspects a business process). The client specified information can be used to instantiate a composite instance (e.g., vertical and/or horizontal implementation) of a business process using a reusable model. For example healthcare client can provide client specified information including specifics how the particular client would like a business process to address claims processing, payer/payee process flows; or a financial system may be handling credit card transaction processing flows; and so forth.

A compile engine 344 compiles a specification representative of the business process. The specification can are based on client specified information provide along with a request for creation of a new business process model (Greenfield information) and/or modification of an existing business process model (e.g., Brownfield information).

A compiled specification i.e., specification representative of a business process accounts for the client specified information and aligns such information with a previously developed business processes model, a reusable business process model, and/or previously developed best practice models from an industry framework set, such as those stored in the library, as described above, and uses such information to compile a specification representative of the business process. The specification can include information to enable deployment and/or management a business process, such as feature development specifications (e.g., estimates of time to develop, service architecture, interfaces to existing systems, resources for the development phase, etc., and/or process-level functional requirements (e.g., transaction scaling policy related to service and/or elemental technology based policies, business level-process monitoring, as described herein, and/or business process-to-application correlation modeling such as that can be used to set up vertical-to-horizontal management interfaces to provide end-to-end coherent modeling of a business process), among other information.

The specification can also include information to enable iterative deployment/management and development to address “front end” changes to a desired operation of business process, such as changes to the client specified information. In some examples, information can be added during deployment and/or management of a business process in addition to information included in the specification compiled during development. For example, information related to a runtime operation of a business process, such information obtained during deployment or subsequent management of a business process in a running domain can be added to the specification.

A delegate engine 346 delegates management operations to a running domain. Delegation refers to delegating control to another engine and/or entity to initiate management operations and/automation associated therewith, for instance, delegating control to running domain engine 347, as described herein. In some examples, delegate engine can delegate control to an IaaS runtime service that initiates management operations to manage the business process. For example, the IaaS runtime service can initiate and execute a management operation or the IaaS runtime service can initiate a management operation that is executed by another entity, such as an entity associated with development of a business process (e.g., the XaaS),

Running domain engine 347 initiates management operations. Management operation can be initiated automatically in response to occurrence of an event and/or occurrence of a “Front end” change to a business process. Specific examples of management operations that can be automatically initiated include, continuous delivery of custom application lifecycle automation, web services application programming interfaces (API), middleware and database lifecycle automation, network lifecycle automation, physical server lifecycle automation, orchestration of workflow and/or runbook lifecycle automation, server virtualization lifecycle automation, and/or storage lifecycle automation, among other management operations to promote managing business processes.

The management operations can be automatically initiated in response to entering/completion of a particular lifecycle phase and/or entering/completion of a sub-phase included in a particular lifecycle include in the lifecycle phases, as described herein. Examples of automation suitable for automatically initiating management operations, such as those described above, can include automated release and deployment management, automated event management (e.g., closed-loop event management), electronic policy management (e.g., SLA management), prescriptive template/and configuration management, usage-based platform capacity management, event ticketing (e.g., eService Desk ticketing including tracking/visualization of delegated policy), policy-driven automated security management, automated continuity management (e.g., preventative/anticipatory disaster recovery), and/or automated release and deployment management, among other types of automation.

An occurrence of an event, for instance, can be identified based on a performance standard and/or based upon a SLA, among other ways to identify an occurrence of an event. For example, an event can be based upon a change (e.g., a change to an environment) resulting in an ability to meet a performance standard (e.g., a “ready” status associated with a newly added computing device 103 to the environment) and/or a change resulting in an inability to meet a performance standard, both which may be driven by heightened usage of the business process by its user community. Occurrences of such events can be automatically identified, for example, by self-diagnosis of a business process using information provided in a specification representative of the business process combined with the information acquired while monitoring/managing the computing resources hosting the business process.

In some examples, the business process (e.g., the business process having the specification representative of the business process) can be included in a plurality of business processes managed by the running domain. That is, the running domain can manage a plurality of business processes (e.g., similar and/or or dissimilar business process) simultaneously using respective specifications representative of each of a managed portion (all of) the plurality of business processes.

In some examples, the running domain engine can include an IaaS runtime service that can initiate management operations to manage a business process. Advantageously, an IaaS runtime service can initiate management operations with the benefit of information included in the composite instance of the business process and/or a specification representative thereof.

In some examples, the instructions to manage include instructions to manage a platform as a service (PaaS) capability with the running domain. A PaaS capability refers to hosting a computing platform such as an operating system, middleware, data bases, autoscaling infrastructure, etc. that can be associated with a business process. Such a capability can be hosted using a cloud-based computing system (e.g., cloud-based computing system 114).

A SaaS capability refers to hosting applications that can be associated with a business process. A SaaS capability can be hosted using a cloud-based computing system. Advantageously, managing a PaaS and/or a SaaS from the running domain (e.g., an IaaS runtime service). The SaaS capability can be included in the above described XaaS.

The management operations, such as those described herein, are included in a runbook. A runbook refers a compilation of management operations (e.g., procedures and/or operations) corresponding to a particular business process. For instance, a runbook for a business process can be based on a specification representative of the business process. The information associated with the runbook (e.g., a name and/or version of the runbook) along with information included in the runbook (e.g., a compilation of management operations) can be displayed in a UI, such as those described herein.

A manage engine (not shown) can manage with the running domain a cloud-based computing system (e.g., cloud-based computing system 114) associated with the business process. A cloud-based computing system associated with the business process refers to cloud-based computing system having computing devices that support/execute some or all of a business process. A business process can be associated with a single cloud-based computing system and/or with multiple cloud-based computing systems,

A current status refers to a comparatively most recent status (e.g., most recent information) associated with a business process. The current status can be stored in an intermediate server, an application server, and/or a data store (e.g., data store 308). In some examples, storing the current status can include replacing the previous status (e.g., a status immediately prior to the current status) with the current status. In some examples, the current status can be stored along with a plurality of other status, for instance, in chronological order based on a time of identification associated with each of the respective statuses.

Identifying information refers to information that can identify a particular business process and/or particular phase(s) of the business process. Identifying information can include information pertaining to a type (e.g., a particular industry associated with) a business process, a name, and/or an identifier, among other identifying information associated with a business process. The identifying information can include information providing a timeframe (e.g., a time such as day, month, etc.) implementation (e.g., deployment) of a business process and/or a timeframe associated with a change to the business process. Such a timeframe can promote the chronological ordering of statues described above and/or periodically management evaluations of the business process.

In some examples, a display engine (not shown) can provide a notification of a change to a business process and/or provide a status (e.g., a current status) of a business process. In some examples, the display engine can cause a display (e.g., cause the display without a user request/user input), for example, a display of a status (e.g., “normal” functioning) associated with a business process. In various examples, the display engine can cause the display, via the GUI, of the information pertaining to a status (e.g., a current status) of the business process and/or the corresponding identifying information associated with the business process.

In some examples, a display engine can provide a notification, such as a notification that a business process has been changed. The notification can include email and/or displaying an indication, such as those described herein. Such a display, can lead to a change to a business process and/or “rolling back” a previous change (unsuccessful) change to a business process to restore the business process to a non-event (e.g., fully functional/“normal”) status.

FIG. 4 illustrates a diagram of an example of a computing device for business process management according to the present disclosure. The computing device 455 can utilize software, hardware, firmware, and/or logic to perform a number of functions described herein.

For example, the computing device 455 can be a combination of hardware and instructions for business process management. The hardware, for example can include a processing resource 460 and/or a memory resource 464 (e.g., computer-readable medium (CRM), data store, etc.) A processing resource 460, as used herein, can include a number of processors capable of executing instructions stored by a memory resource 464. Processing resource 460 can be integrated in a single device or distributed across multiple devices. The instructions (e.g., computer-readable instructions (CRI)) can include instructions stored on the memory resource 464 and executable by the processing resource 460 to implement a desired function (e.g., initiate a management operation, etc.).

The memory resource 464 can be in communication with a processing resource 460. A memory resource 464, as used herein, can include a number of memory components capable of storing instructions that can be executed by processing resource 460. Such memory resource 464 can be a non-transitory CRM. Memory resource 464 can be integrated in a single device or distributed across multiple devices. Further, memory resource 464 can be fully or partially integrated in the same device as processing resource 460 or it can be separate but accessible to that device and processing resource 460. Thus, it is noted that the computing device 455 can be implemented on a computing device and/or a collection of computing devices, on a workstation and/or a collection of workstations, and/or on a combination of the computing devices and the workstations.

The memory resource 464 can be in communication with the processing resource 460 via a communication link (e.g., path) 462. The communication link 462 can be local or remote to a computing device associated with the processing resource 460. Examples of a local communication link 462 can include an electronic bus internal to a computing device where the memory resource 464 is one of volatile, non-volatile, fixed, and/or removable storage medium in communication with the processing resource 460 via the electronic bus.

The memory resource 464 can include a number of modules such as an instantiate module 466, a compile module 468, a delegate module 470, and a management module 472, etc. The number of modules 466, 468, 470, 472 can include CRI that when executed by the processing resource 460 can perform a number of functions. The number of modules 466, 468, 470, 472 can be sub-modules of other modules. For example, the instantiate module 466 and the compile module 468 can be sub-modules and/or contained within the same computing device. In another example, the number of modules 466, 468, 470, 472 can comprise individual modules at separate and distinct locations (e.g., CRM, etc.).

Each of the number of modules 466, 468, 470, 472 can include instructions that when executed by the processing resource 460 can function as a corresponding engine, including those as described herein. For example, the instantiate module 466 can include instructions that when executed by the processing resource 460 can function as the instantiate engine 343, for instance, to instantiate a composite instance of a business process based on a business process model. Similarly, the instantiate module 466 can instantiate a library, as described herein, including a plurality of reusable business process models and/or instantiate a composite instance of a business process using a reusable business process model of the plurality of reusable business process models. In some examples, the instantiate module 466 can instantiate a new business process and/or an existing business process, as described herein.

A compile module 468 can include instructions that when executed by the processing resource 460 can function as a compile engine 344 to compile a specification representative of a business process. The specification representative of the business process can include information on application and/or service created for the business process, such as, information that can enable creation, deployment, and/or management of the application and/or service consist with a business process for which the application and/service was created for.

The delegate module 470 can include instructions that when executed by the processing resource 460 can function as the delegate engine 346 to delegate management operations to a running domain, as described herein. The manage module 472 can include instructions that when executed by the processing resource 460 can function as a manage engine (not shown) to manage, with the running domain, a cloud-based computing system associated with the business process. The manage module 472 can instructions to manage a PaaS capability and/or a SaaS capability with the running domain, as described herein.

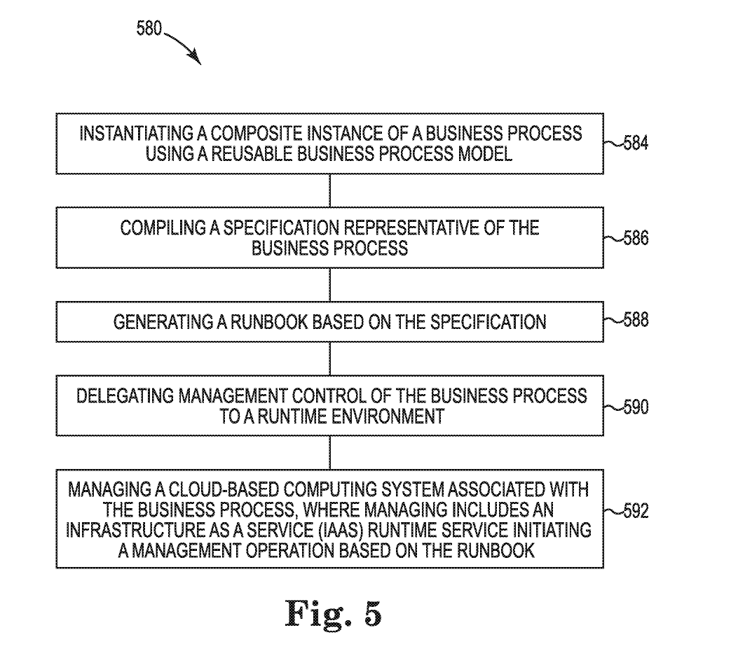

FIG. 5 illustrates a flow diagram of an example of a method for business process management according to the present disclosure. As shown at block 584, in various examples, the method 580 can include instantiating a composite instance of a business process using a reusable business process model.

As shown at block 586, the method 580 can include compiling a specification representative of the business process. The speciation can include information, such as information related to a front-end change, as described herein. In various examples, the method 580 can include, generating a runbook, as described herein, based on the specification as shown at block 588.

The method 580, as shown a block 590, can include delegating management control of the business process to a running domain. Delegation of control can be accomplished by passing information to a running domain (e.g., information that authorizes a running domain to initiate management operations) and/or removes authorization from a non-running domain (e.g., those associated with the development and/or deployment of the business process).

As shown at block 592, the method 580 can include managing a cloud-based computing system associated with the business process, where managing includes an IaaS runtime service initiating a management operation based on the runbook. In some examples, the management operation is not initiated by entities (e.g. a centralized control point having at least a portion of which located outside of a running domain) other than the laaS runtime service, Advantageously, an IaaS runtime service can initiate management operations with the benefit of information included in the composite instance of the business process and/or a specification representative thereof.

In some examples, managing can include the IaaS runtime service to automatically initiate the management operation in response to a change to the specification. For example, a management operation can be automatically initiated in response to a “Front-end” change provided be a client and resultant change to a specification. Managing can, in some examples, include managing a cloud-based computing system including a plurality of databases located at a plurality of locations, such as computing devices 103-1, . . . 103-A and cloud-based computing system 114, as illustrated in FIG. 1.

In some examples, the method 580 can include displaying an electronic representation indicative of a status of a business process and/or a status of an application or service created for the business process. Such a display can be displayed via a UI. The UI (not shown) can be displayed via a display of a workstations (e.g., workstation 110-2), for example in response to an occurrence of an event (such as a “Front-end” change), as described herein. The UI can include a plurality of electronic representations (not shown), a plurality of names and/or a plurality of statuses corresponding to a plurality of business process and/or applications and/or services created for the plurality of business processes, among other displayed items included in the UI. For example, a UI can simultaneously display of a particular total number of business process, application, and/or services utilizing a cloud-based computing system and/or computing device(s) within the cloud-based computing system, however, the present disclosure is not so limited. Rather, the displayed items (e.g., the a plurality of electronic representations, etc.) can be varied and/or include more of less displayed items to promote business process management, as described herein

The plurality of electronic representations can each have functionality (e.g., a respective functionality) associated therewith. For example, selection of an electronic representation may cause the UI to perform an action (e.g., display a drop down menu, display a free text area, display a drill down menu, and/or cause an application utilizing the UI to perform a function). That is, the plurality of electronic representations and/or a plurality of statuses can facilitate a user to interact with the UI (e.g., provide an input to cause the UI to perform the functionality). For example, displaying the electronic representation can include providing, via an asynchronous message protocol (e.g., XML), the indication to a graphical user interface (GUI)

In some examples, displaying can include causing a simultaneous display of a plurality of electronic representations, indicative of respective statuses associated with each of a plurality of business processes, applications, and/or services. A simultaneous display refers to displaying the statuses (e.g., current statuses) of a plurality of business processes, a plurality of applications, and/or a plurality of services at the same time via an individual device (e.g., a single GUI of the individual device).

Causing can include executing instructions stored in memory to directly cause a computing device to display, for example, electronic representations, indicative of respective statuses associated with each of the plurality of business processes and/or to communicate data with an expectation that it be processed by another device to cause the computing device to display the electronic representations, for example, those indicative of respective statuses associated with each of the plurality of business processes. Similarly, blocks 584, 586, 588, 590, 592 can include executing instructions, for example, as described with regard to the engines herein, stored in memory to perform the examples of the method described therein.

In some examples, the method 580 can include remediating the event based upon the display of the electronic representation indicative of the event (e.g., an “event” status associated with a business process). Remediation refers to restoration of a non-event status (e.g., a status of a business process in compliance with an SLA). For example, a change to a business process (e.g., a recent change) can be “rolled-back”, for instance, by automatically imitating a management operation, to restore the business process to a non-event status.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processing resource. The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 308 in FIG. 3.

In the detailed description of the present disclosure, reference is made to the accompanying drawings that form a part hereof, and in which is shown by way of illustration how examples of the present disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

As will be appreciated, elements shown in the various examples herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. As used herein, “a number of” an element and/or feature can refer to a number of such elements and/or features. In addition, “for example” and similar phrasing is intended to mean, “by way of example and not by way of limitation”.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A system for business process management, comprising a processing resource in communication with a non-transitory computer readable medium having instructions executable by the processing resource to implement a instantiate engine, a compile engine, a delegate engine, and a running domain engine, wherein:
the instantiate engine instantiates a composite instance of a business process based on a business process model;
the compile engine compiles a specification representative of the business process;
the delegate engine delegates management operations to a running domain; and
the running domain engine initiates management operations.

2. The system of claim 1, wherein the running domain engine includes an infrastructure as service (laaS) runtime service, and wherein the instructions include instructions to implement the delegate engine to delegate control to the IaaS runtime service that initiates management operations.

3. The system of claim 1, wherein the instructions include instructions to implement the running domain engine to initiate management operations including application versioning.

4. The system of claim 1, wherein business process is included in a plurality of business processes managed by the running domain.

5. The system of claim 1, wherein the instructions include instructions to implement the running domain engine to initiate management operations included in a runbook, and wherein the runbook is based on the specification.

6. The system of claim 1, wherein the instructions include instructions to implement the instantiate engine to instantiate the composite instance of the business process based on a reusable business process model.

7. A non-transitory computer-readable medium storing instructions executable by a processing resource to:
instantiate a library including a plurality of reusable business process models;
instantiate a composite instance of a business process using a reusable business process model of the plurality of reusable business process models;
compile a specification representative of the business process;
delegate management control of the business process to a running domain; and
manage, with the running domain, a cloud-based computing system associated with the business process.

8. The medium of claim 7, wherein the instructions to instantiate include instructions to instantiate a new business process.

9. The medium of claim 7, wherein the instructions to instantiate include instructions to instantiate a portion of an existing business process.

10. The medium of claim 7, wherein the instructions to manage include instructions to manage a platform as a service (PaaS) capability with the running domain.

11. The medium of claim 7, wherein the instructions to manage include instructions to manage a software as a service (SaaS) capability with the running domain.

12. A method for business process management, comprising:
instantiating a composite instance of a business process using a reusable business process model;
compiling a specification representative of the business process;
generating a runbook based on the specification;
delegating management control of the business process to a running domain; and
managing a cloud-based computing system associated with the business process, wherein managing includes an infrastructure as a service (IaaS) runtime service initiating a management operation based on the runbook.

13. The method of claim 12, wherein delegating includes delegating control such that the management operation is not initiated by entities other than the IaaS runtime service.

14. The method of claim 12, wherein managing includes the laaS runtime service to automatically initiate the management operation in response to a change to the specification.

15. The method of claim 15, wherein managing includes managing a cloud-based computing system including a plurality of databases located at a plurality of locations.
